(19) United States
(12) Patent Application Publication
(10) Pub. No.: US 2020/0293175 A1
(43) Pub. Date: Sep. 17, 2020

(54) THREE-DIMENSIONAL INTERACTIVE USER INTERFACE

(71) Applicant: Marbleverse Inc., Los Angeles, CA (US)

(72) Inventors: Robert FAIR, Los Angeles, CA (US); Taylor MARTYR, Los Angeles, CA (US)

(21) Appl. No.: 16/352,727

(22) Filed: Mar. 13, 2019

(51) Int. Cl. G06F 3/0481; G06F 3/0484

(52) U.S. Cl. CPC G06F 3/04815; G06F 3/0484

(57) ABSTRACT

A method for presenting content in a three-dimensional graphical user interface (GUI) is presented. The method includes obtaining content from a first data source to generate a first content feed and displaying the first content feed at a central graphical object. The method also includes obtaining content content from a second data source to generate a second content feed and displaying the second content feed at an aggregator graphical object. The method further includes displaying content associated with the second content feed at a content graphical object.

### BACKGROUND

### Field

Certain aspects of the present disclosure generally relate to an interactive user interface and, more particularly, to a system and method for generating an interactive three-dimensional (3D) user interface.

### Background

Conventional user interfaces (UIs) have evolved from text-only UIs to graphical user interfaces (GUIs). In conventional systems, a GUI displays various icons. Each icon corresponds to a different task or application. The user may interact with the GUI via an input device, such as a mouse, a keyboard, or a finger. A number of applications provided on a device, such as a mobile phone, may increase as the computing resources of the device is increased.

The increased number of applications also increases a number of icons displayed on a GUI. The increased number of icons reduces a user experience because the user may find it difficult to find a desired application. To improve the user experience, conventional systems may create menus, applications groups, or use a 3D interface. These conventional systems merely reorganize the icons to reduce clutter. It is desirable to further improve GUIs by providing an interface that provides application and content aggregation.

### SUMMARY

In one aspect of the present disclosure, a method for presenting content in a three-dimensional (3D) graphical user interface (GUI) is disclosed. The method includes displaying the first content feed at a central graphical object. The method also includes obtaining content from at least a second data source to generate a second content feed. The method further includes displaying the second content feed at an aggregator graphical object. The method still further includes displaying content associated with the second content feed at a content graphical object.

In another aspect of the present disclosure, a non-transitory computer-readable medium with non-transitory program code recorded thereon is disclosed. The program code is for presenting content in a 3D GUI. The program code is executed by a processor and includes program code to display the first content feed at a central graphical object. The program code also includes program code to obtain content from at least a second data source to generate a second content feed. The program code further includes program code to display the second content feed at an aggregator graphical object. The program code still further includes program code to display content associated with the second content feed at a content graphical object.

Another aspect of the present disclosure is directed to an apparatus for presenting content in a 3D GUI. The apparatus having a memory and one or more processors coupled to the memory. The processor(s) is configured to display the first content feed at a central graphical object. The processor(s) is also configured to obtain content from at least a second data source to generate a second content feed. The processor(s) is further configured to display the second content feed at an aggregator graphical object. The processor(s) still further configured to display content associated with the second content feed at a content graphical object.

This has outlined, rather broadly, the features and technical advantages of the present disclosure in order that the detailed description that follows may be better understood. Additional features and advantages of the present disclosure will be described below. It should be appreciated by those skilled in the art that this present disclosure may be readily utilized as a basis for modifying or designing other structures for carrying out the same purposes of the present disclosure. It should also be realized by those skilled in the art that such equivalent constructions do not depart from the teachings of the present disclosure as set forth in the appended claims. The novel features, which are believed to be characteristic of the present disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIGS. 1A, 1B, and 1C illustrate examples of conventional graphical user interfaces (GUIs).

FIGS. 2, 3A, and 3B illustrate examples of a central graphical object view of a 3D, rotational, GUI according to aspects of the present disclosure.

FIG. 4 illustrates an example of a view of an aggregator graphical object of a 3D, rotational, GUI according to aspects of the present disclosure.

FIG. 5 illustrates an example of heads-up display (HUD) controls according to aspects of the present disclosure.

FIG. 6 illustrates an example of converting web content to a 3D, rotational, GUI according to aspects of the present disclosure.

FIG. 7 illustrates an example for generating and providing cross-platform suggestions according to aspects of the present disclosure.

FIGS. 8A, 8B, 8C, 9, and 10 illustrate examples of a 3D, rotational, GUI according to aspects of the present disclosure.

FIG. 11 is a flow diagram for presenting content in a 3D GUI according to aspects of the present disclosure.

FIG. 12 is a block diagram conceptually illustrating a computing device, according to aspects of the present disclosure.

FIG. 13 illustrates a computer network for use with a 3D, rotational, GUI according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts.

In conventional systems, a conventional GUI displays various icons on a device's display. The device may include, for example, a personal computer, a mobile device, a vehicle, a television, or another type of device with a display. Each icon corresponds to a different task or application. A user may interact with the GUI via an input device, such as a mouse, a keyboard, or a finger. A number of applications provided on the device may increase as the computing resources of the device is increased.

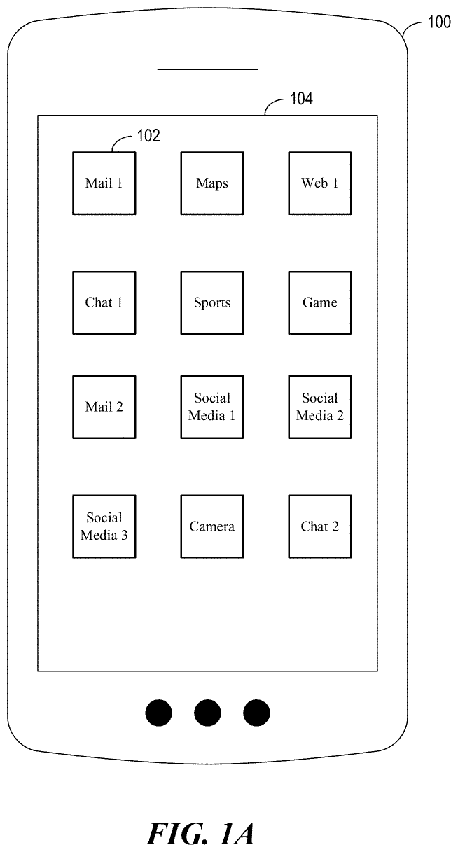

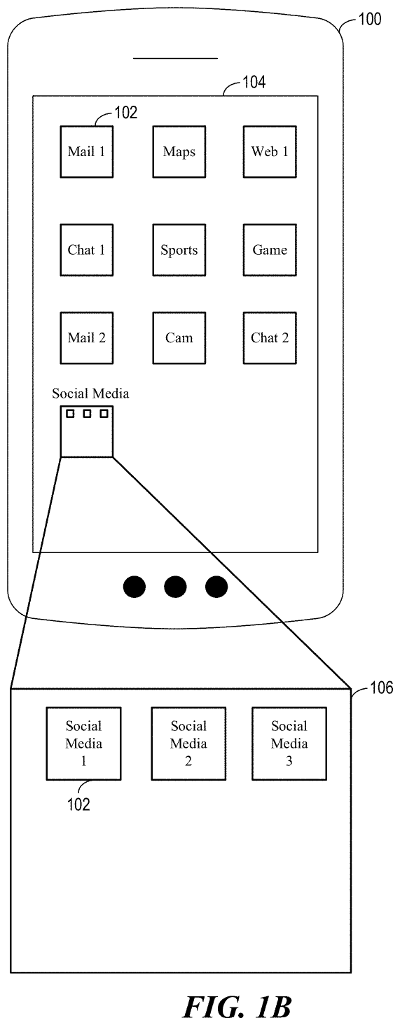

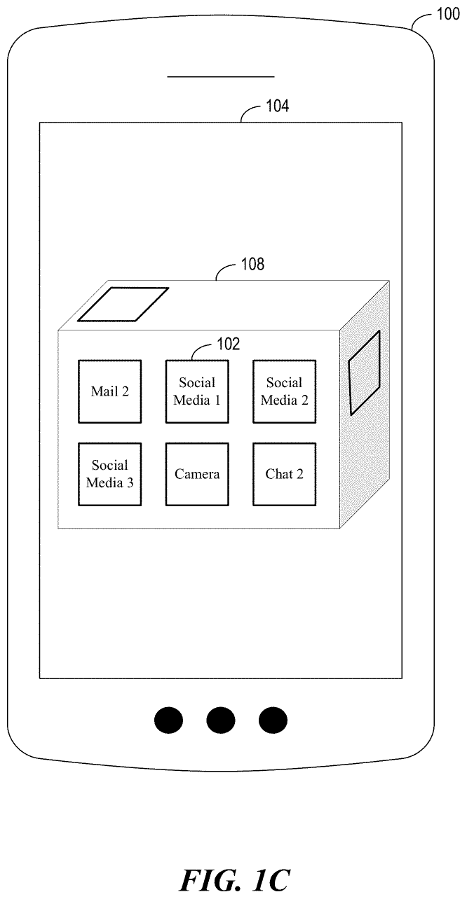

The increased number of applications also increases a number of icons displayed on a conventional GUI. The increased number of icons may clutter the screen. FIG. 1A illustrates an example of a device 100 with a conventional GUI that displays multiple icons 102 on the display unit 104 of the device 100. Each icon 102 may be associated with a specific application.

A user may install multiple applications associated with a specific function. For example, as shown in FIG. 1A, the device 100 may include multiple mail applications (e.g., mail 1 and mail 2) and multiple social media applications (e.g., social media 1, social media 2, and social media 3). Each application is associated with a unique icon 102. As shown in FIG. 1A, the icons may clutter the display 104 of the device 100.

The cluttered display 104 may increase a difficulty in finding an application. The difficulty in finding an application may be further increased when the display may include multiple pages, with each page including multiple icons. For example, a user may want to find a post in a specific social media application (e.g., social media 2). The user may have to search for the social media 2 icon 102 amongst the other icons 102. The user would also have to search in the social media 2 application for the specific message. The time needed to search through multiple icons 102 and through the application feed may reduce the user's overall experience.

To improve the user experience, multiple icons 102 may be grouped in a folder 106, as shown in FIG. 1B. The multiple icons 102 may be grouped by a user or by software on the device 102. The multiple icons 102 in the folder 106 may be related. For example, as shown in FIG. 1B, the folder 106 includes icons 102 associated with social media applications. The folder 106 may also include un-related icons 102.

Grouping icons 102 into a folder 106 may reduce clutter and improve accessibility to applications (e.g., icons 102) in comparison to some conventional GUIs and UIs. Still, to execute an application, the user needs to identify the correct folder 106 and search for an icon 102 within the correct folder 106. As such, the time needed to search through multiple folders 106 to find a specific icon 102 may reduce the user's overall experience.

Additionally, when icons 102 are grouped into a folder 106, the feeds of the applications corresponding to the grouped icons 102 are not consolidated. For example, in FIG. 1B, when the social media icons 102 are grouped into the folder 106, the user needs to separately open each application to access the corresponding social media feed. In the conventional GUI of FIG. 1B, the user cannot open one of the grouped icons 102 to view a consolidated feed from all social media applications installed on the device 100.

Some conventional GUIs have attempted to improve the user experience by placing one or more icons 102 on a face of a cube 108, as shown in FIG. 1C. A user may rotate the cube 108 in three-dimensional space (e.g., x, y, and z coordinates). Related icons 102 may be placed on a specific face. Alternatively, the icons 102 may be randomly placed on one of the cubes' 108 faces.

Placing icons 102 on a cube 108 may reduce clutter and improve accessibility to applications (e.g., icons 102) in comparison to some conventional GUIs and UIs. Still, to execute an application, the user needs to identify a face of the cube 108 with the icon 102. Additionally, if multiple cubes 108 are defined in the GUI, the user may need to search amongst multiple cubes 108 to find the icon 102 associated with a desired application. As such, the time needed to search the cube 108 for an icon 102 may reduce the user's overall experience. Additionally, when icons 102 are placed on a face of the cube 108, the feeds of the applications corresponding to related icons 102 are not consolidated.

It is desirable to improve GUIs by improving accessibility to applications. It is further desirable to improve accessibility by consolidating feeds of related applications, thereby reducing a number of applications that need to be opened by the user. Aspects of the present disclosure are directed to a interactive GUI with multiple objects defined within a three-dimensional space. The interactive GUI may be referred to as a three-dimensional interactive GUI or a three-dimensional, rotational, GUI. Each object may be associated with an application, a task, a consolidated feed, a website, content (e.g., videos, pictures, audio, text, messages, etc.), or another component.

In one configuration, the interactive GUI is represented as a planetary orbit system (e.g., solar system). Each planet may correspond to a different object. The planetary orbit system may be animated to rotate around a central body (e.g., home planet). A user may interact with the planetary orbit system by zooming in and out of the planetary orbit system. The user may also visit specific planets to access additional functionality.

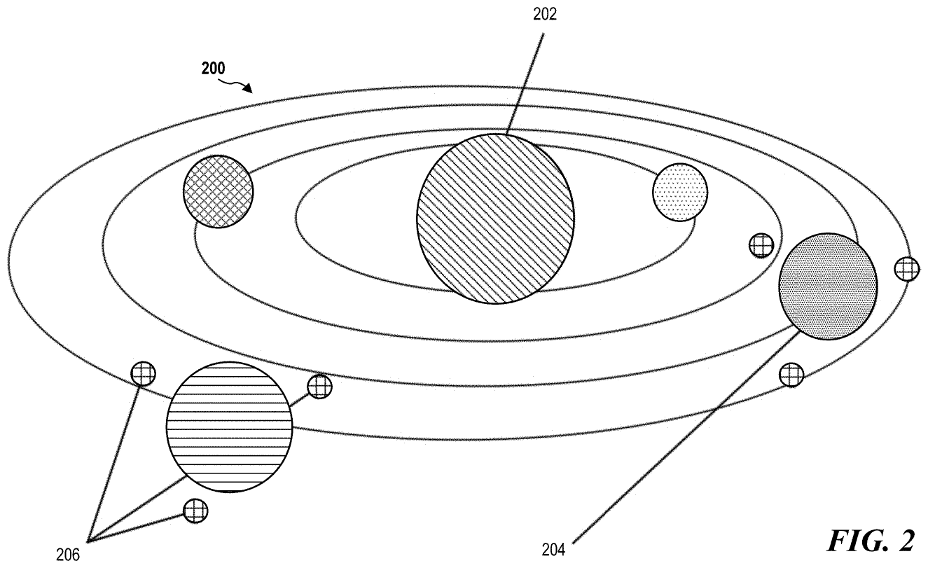

FIG. 2 illustrates an example of a home planet view of a planetary orbit system 200 according to aspects of the present disclosure. As shown in FIG. 2, the planetary orbit system 200 includes a home planet 202 (e.g., central graphical object), aggregator planets 204 (e.g., aggregator graphical object), and content moons 206 (e.g., content graphical object). The aggregator planets 204 may be animated to rotate around the home planet 202. The content moons 206 may be animated to rotate around the aggregator planets 204. The content moons 206 may also be referred to as application moons.

The planetary orbit system 200 may be displayed on a device's display. The animation may occur while the planetary orbit system 200 is displayed. For example, the aggregator planets 204 may rotate around the home planet 202. The home planet 202 may serve as a starting point for the user.

Aspects of the present disclosure are not limited to a planetary orbit system. Other interactive 3D interfaces are contemplated. The planets may be replaced by other types of objects, such as cars racing on a racetrack. The user may configure the objects based on user preference. That is, the color, texture, theme, and/or animation of one or more components (e.g., home planet 202, aggregator planets 204, and/or content moons 206) of the interactive GUI may be modified by the user. For simplicity, aspects of the present disclosure will be discussed in relation to the planetary orbit system.

In one configuration, an aggregator planet 204 displays a content feed generated by aggregating data sourced from multiple data feeds. The data feeds may include Internet content (e.g., web content), application data, or other types of data, such as text messaging data. For example, an aggregator planet 204 may represent an individual website or application (e.g., web search), where one or more content moons 206 orbiting the aggregator planet 204 represent links, content, features, etc., of the website or application. The data may be sourced via an application programming interface (API) of each application.

The data sources used for an aggregator planet's 204 content feed may be combined based on an application store (e.g., Apple™ app store) classification. For example, applications may be categorized as social media, video, mail, games, etc. Additionally, or alternatively, the applications may be categorized from a user setting and/or a stored library of categories and classifications. The categorization is used to generate data feeds for the aggregator planet 204. The applications used to generate the data feeds may be displayed as content moons 206.

One or more content moons 206 may orbit each aggregator planet 204. The orbit of the content moons 206 may be animated. The content moons 206 provide data corresponding to the data feed for the aggregator planet 204. For example, the content moons 206 may provide access to third-party applications, a friends list, and/or other data. In one example, when an aggregator planet 204 represents a website or web application, the content moons 206 may represent links, content, features, etc. of the website or web application. To remove clutter, the content moons 206 may or may not be displayed in the home planet view.

In the home planet view of FIG. 2, the home planet 202 may display general information, such as time, weather, date, a number of unread messages, and/or other information. For example, the home planet 202 may display notifications and/or content from one or more aggregator planets 204 in the planetary orbit system 200. The information displayed on the home planet 202 may be configured by the user. Additionally, in the home planet view of FIG. 2, each aggregator planet 204 may display an icon corresponding to the type of data feed provided by the aggregator planet 204. For example, an aggregator planet 204 corresponding to e-mail data feeds may display an e-mail icon.

When the planetary orbit system 200 is displayed, the user may select one of the displayed aggregator planets 204. The aggregator planet 204 may be selected via a user input, such as an on-screen touch, a mouse click, a voice command, or an input via another type of input device. In response to the user's selection, the GUI zooms to the selected aggregator planet 204 to display the content that is mapped to the selected aggregator planet 204. The GUI may animate the zoom into the selected aggregator planet 204.

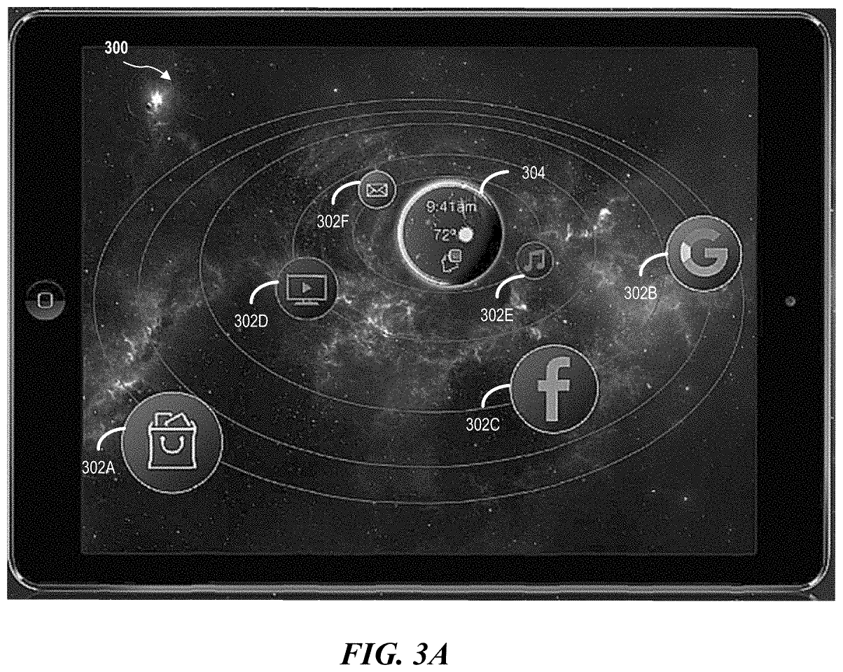

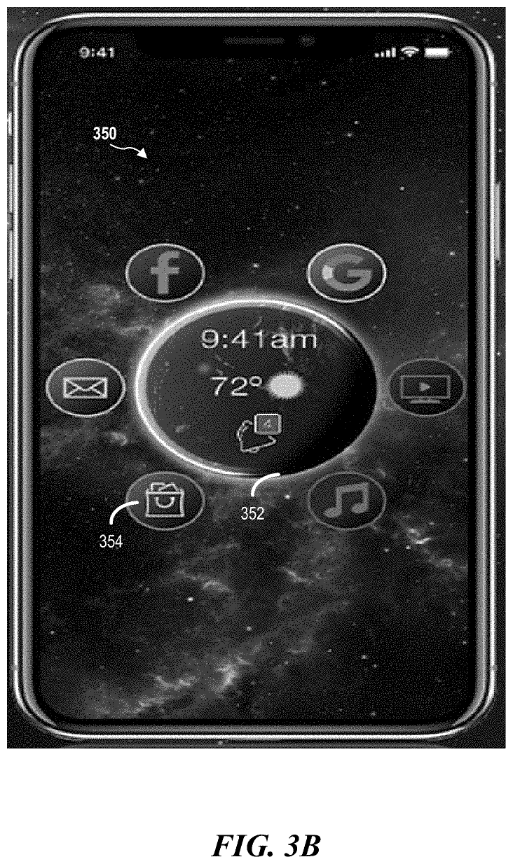

FIG. 3A illustrates another example of a home planet view 300 according to aspects of the present disclosure. As shown in FIG. 3A, multiple aggregator planets 302A, 302B, 302C, 302D, 302E, 302F orbit a home planet 304. Each aggregator planet 302A, 302B, 302C, 302D, 302E, 302F is associated with a different application or website.

For example, a first aggregator planet 302A is associated with retail applications. In this example, the first aggregator planet 302A aggregates content from multiple retail applications and/or websites. A second aggregator planet 302B may be associated with a specific search website. The aggregator planets 302A, 302B, 302C, 302D, 302E, 302F may be animated to rotate around the home planet 304.

In one configuration, a compact home planet view is used. The compact home planet view may be used on a device with a limited display, such as a mobile device. FIG. 3B illustrates an example of a compact home planet view 350 of a planetary orbit system according to aspects of the present disclosure. In the compact home planet view 350, a home planet 354 is displayed with orbiting aggregator planets 352.

As discussed, an aggregator planet 352 may combine content (e.g., data) sourced from various data sources. Alternatively, an aggregator planet 352 may be associated with a specific website or application. The planetary orbit system may include multiple aggregator planets 352. The content or application of one aggregator planet 352 is different from the combined content or application of the other aggregator planets 352.

The home planet 354 also combines content sourced from various data sources or aggregator planets 352. For the home planet 354, the content may be selected by the user. Additionally, or alternatively, the content may be selectively sourced based on a user's habits. For example, the content may include content that is popular with the user and/or content related to popular content.

In one configuration, the content of the home planet 354 is organized in a scrollable feed (e.g., vertically scrollable feed). The feed may include, but is not limited to, application notifications, posts, messages, reminders, photos, and video. The content may be displayed based on time or user preference. For example, the most recent content may be displayed first. As another example, content is prioritized based on the user's interaction. In this example, if the user reads news from a first website more than a second website, the content associated with the first website is prioritized over the content of the second friend.

The user may scroll through the content via vertical scrolling arrows. The home planet 354 may also include horizontal rotation arrows. The user may select one of the horizontal rotation arrows to horizontally rotate the home planet 354. When scrolled horizontally, in either direction, the home planet 354 reveals content columns. Each content column filters the combined content into discrete categories.

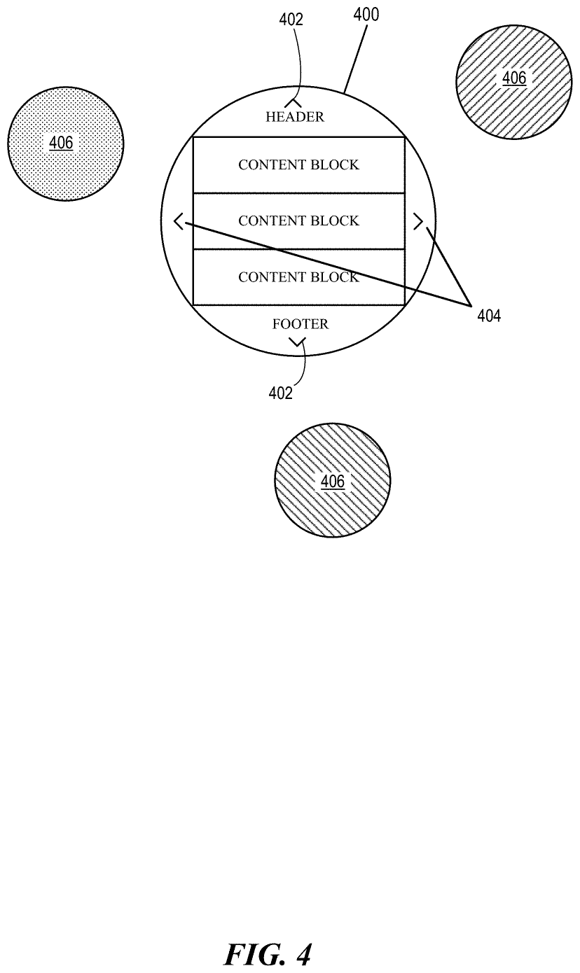

FIG. 4 illustrates an example of a view of an aggregator planet 400 according to aspects of the present disclosure. The aggregator planet 400 may be displayed according to the example of FIG. 4 in response to a user selecting the aggregator planet 400 from a home planet view (see FIGS. 2 and 3A-B). As discussed, the aggregator planet 400 combines content (e.g., data) sourced from various data sources. The system may include multiple aggregator planets 400. The combined content of one aggregator planet 400 is different from the combined content of the other aggregator planets 400.

In one configuration, the content is organized in a scrollable feed (e.g., vertically scrollable feed). The feed may include, but is not limited to, application notifications, posts, messages, reminders, photos, and video. The content may be displayed based on time or user preference. For example, the most recent content may be displayed first. As another example, content is prioritized based on the user's interaction. In this example, if the user interacts with a first friend more than a second friend, the content associated with the first friend is prioritized over the content of the second friend.

The user may scroll through the content via vertical scrolling arrows 402. The aggregator planet 400 may also include horizontal rotation arrows 404. The user may select one of the horizontal rotation arrows 404 to horizontally rotate the aggregator planet 400. When scrolled horizontally, in either direction, the aggregator planet 400 reveals content columns. Each content column filters the combined content into discrete categories.

The vertical scrolling arrows 402 and horizontal rotation arrows 404 may be defined in different locations in the aggregator planet 400 or home planet (not shown in FIG. 4). Also, the vertical scrolling arrows 402 and horizontal rotation arrows 404 are optional, the content feed may be scrolled or rotated horizontally based on an input received at a specific location of the aggregator planet 400 or home planet. For example, the content feed may be scrolled up in response to an input received in an area of the header.

One or more content moons 406 may orbit the aggregator plant 400. Each content moon 406 represents an individual third-party application, content that is being sourced, and/or functionality associated with the sourced content. For example, if the aggregator planet 400 sources content from different social media applications, each content moon 406 may be associated with the respective social media applications. In this example, selecting the content moon 406 may execute the social media application or cause the aggregator plant 400 to only display content from the selected content moon 406.

The aggregator planet 400 may include a header section, a footer section, and multiple content blocks. The header section may display a title, such as a planet title (e.g., social planet, friends planet, etc.), a name of an application, a title corresponding to the displayed content, etc. The footer may display other information related to the displayed content. Alternatively, the footer may display the navigation arrows 402, 404. The content blocks are used to display the content. The content blocks may be presented as a list, as tiles, or in another configuration.

In a home planet view, aggregator planets 400 are shown as orbiting the home planet. When a user clicks on (e.g., selects) an orbiting aggregator planet, the GUI may zoom in to the aggregator planet 400 to reveal the application icon or content that is mapped to the face of the selected aggregator planet 400. Each aggregator planet 400 serves as a gateway to launch a specific application. In one configuration, the application launched from the aggregator planet 400 is a third-party application that is outside of the GUI platform. Additionally, or alternatively, an aggregator planet 400 may be mapped to various types of content from applications that are supported within the GUI platform.

When zoomed in on aggregator planet 400, as shown in FIG. 4, a user may provide input on the aggregator planet 400. For example, the user may click on the aggregator planet 400, via an input device, to access layers of content or various interactions, based on the type of content that is displayed on the aggregator planet 400. For example, the user may visit an aggregator planet 400 associated with the user's friends (e.g., “friend aggregator planet”). Each friend, or a set of friends, may be displayed on content moons 406 associated with the friend's aggregator planet 400. Clicking on a friend's face zooms into the selected content moon 406, such that the user may direct message the friend associated with the content moon.

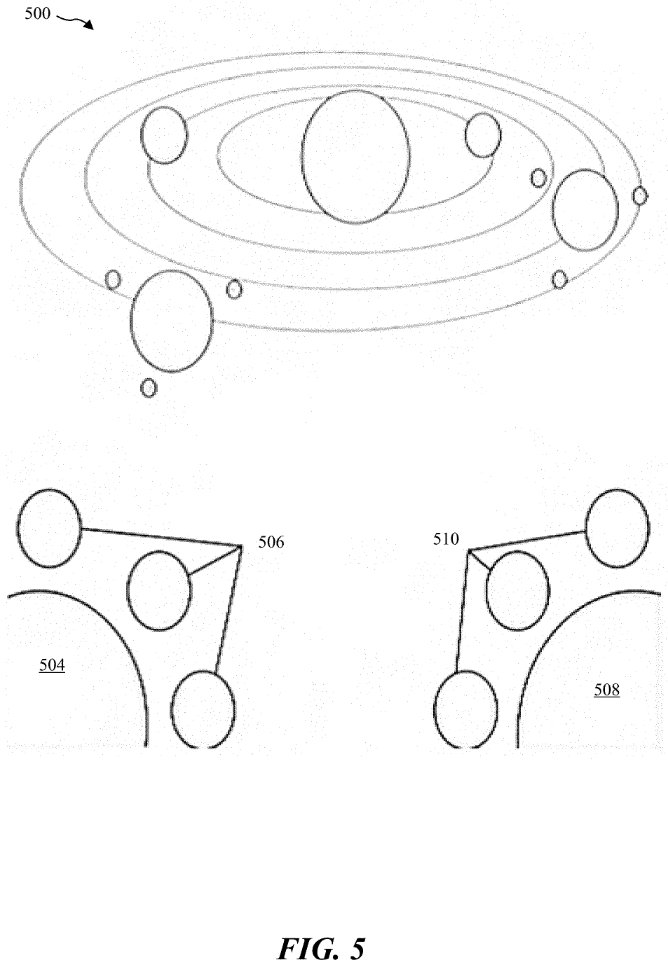

To improve navigation, heads-up display (HUD) controls may be used. FIG. 5 illustrates an example of HUD controls according to aspects of the present disclosure. The HUD controls may persistently appear on the GUI. In the example of FIG. 5, the HUD controls are displayed with a home planet view 500.

The HUD controls include a navigation control 504. The navigation control 504 provide shortcuts to any destination within the GUI, such as planets, moons, applications, or content. The shortcuts reduce navigation times throughout the platform. The navigation control 504 may include navigation sub-controls 506. The navigation sub-controls 506 may provide shortcuts to specific planets, moons, applications, or content. The navigation control 504 may provide a shortcut to the home planet view 500 when the GUI is in another view, such as an aggregator planet view.

Depending on the current location of the user within the platform, the HUD controls may change to provide other destination shortcuts. The HUD controls may include an action control 508 and action sub-controls 510. The action control 508 and action sub-controls 510 provide shortcuts to features within each layer of the platform. The functionality associated with the action control 508 and action sub-controls 510 is dynamic. That is, the functionality may adapt to the currently displayed context. For example, when a user views a planet or moons displaying video content, the action control 508 and action sub-controls 510 may change to the play, volume, full screen, and/or other controls associated with a video. Both the action sub-controls 510 and navigation sub-controls 506 may rotate (e.g., revolve around the center) to reveal additional button choices.

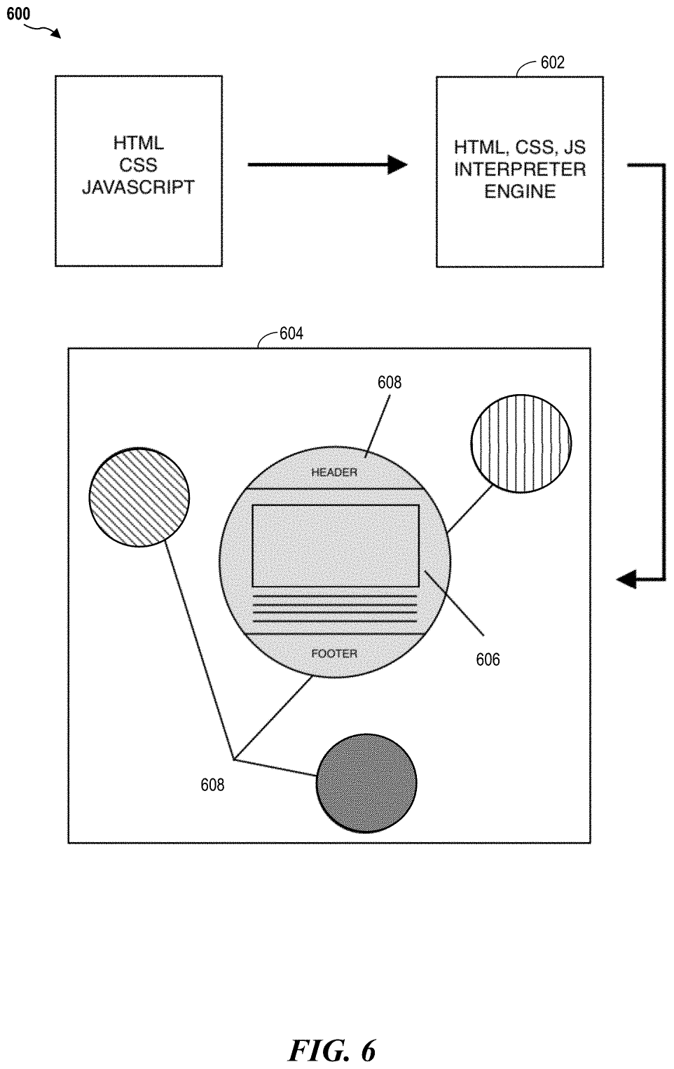

The GUI platform of the current disclosure may be used to display web content. FIG. 6 illustrates an example 600 for converting web content to a three-dimensional, rotational, GUI according to aspects of the present disclosure. As shown in FIG. 6, a developer uses an existing website/web-based application (e.g., HTML, CSS, and Javascript) to generate a 3D, rotational, GUI according to aspects of the present disclosure.

The developer may be a third-party developer or a developer for the platform. Software development kit (SDK) guidelines may be provided to developers. If desired, a developer may conform their existing code according to the SDK guidelines. Conforming a website's existing code to the SDK guidelines may improve the websites integration with the 3D, rotational, GUI.

At block 602, the conformed code may be submitted to a proprietary interpreter engine. Once submitted, the proprietary interpreter engine reformats the existing website to be displayed in the 3D, rotational, GUI (block 604). The website content may be displayed in a planetary system configuration. Content 606 may be reformatted to display on the face of a planet 608. The original website's navigation menus and/or other content is displayed on moons 610 that orbit the planet 608, allowing users to access other areas of the site.

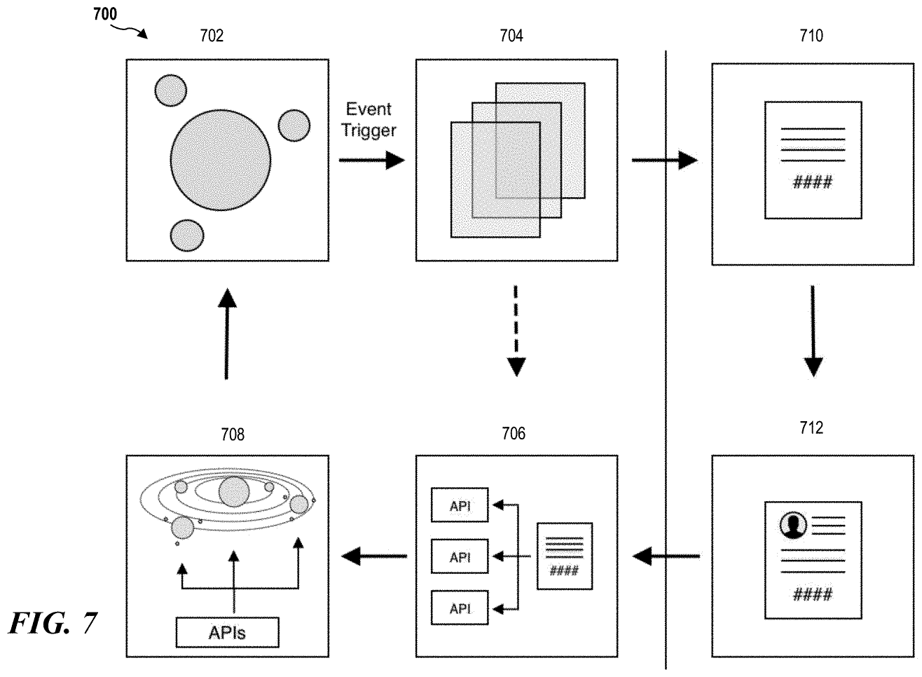

Aspects of the present disclosure analyze user behavior across multiple applications to provide cross-platform suggestions. FIG. 7 illustrates an example 700 for generating and providing cross-platform suggestions according to aspects of the present disclosure. As shown in FIG. 7, at block 702, a user interacts with application content. The interaction may include reading a social media feed, visiting a website, buying a product, direct messaging a friend, or any other type of interaction with content provided via the platform.

At block 704, the platform generates a meta-data entry based on the user's interaction. The meta-data may be stored locally on the device executing the platform. At block 706, the meta-data entry is distributed to APIs of applications installed on the user's device. At block 708, the APIs populate relevant content to other applications hosted on the platform. The process from block 704 to block 708 may be used for real-time content update (e.g., content prioritization).

For example, a user may visit a musician's social media page via a social network. The interaction with the musician's social media page may trigger an event and generate a meta-data entry. The meta-data entry may be stored in local storage. The meta-data entry may be distributed to APIs of multiple applications associated with the platform.

The APIs may query for content associated with the meta-data entry. For example, an API for a video streaming application may query for content associated with the musician. As another example, an API for an online shopping application may query for products associated with the musician. The queried content may be displayed with other data that is aggregated in a feed of a content planet or home planet. Additionally, the queried content may be prioritized over the other data that is aggregated in the feed of the content planet or home planet.

Additionally, as shown in FIG. 7, at block 710, the meta-data is transmitted to a database. The database may be remote or local. The meta-data may be analyzed and categorized. A hashtag may be used to provide a layer of categorization. The categorization may improve a speed for providing content suggestions.

The user's meta-data may be analyzed based on meta-data from other users. The other users may be similar to the user in one or more demographics. At block 712, based on the analyzed and categorized meta-data, a user-profile may be updated. The updated user-profile may be distributed to APIs (block 706). Additionally, at block 708, the APIs populate relevant content to other applications hosted on the platform. A time for populating relevant content based on the updated user-profile (block 712) may be greater than a time for populating relevant content based on interaction meta-data (block 704).

As discussed above, in one example, a user may visit a musician's social media page via a social network. The interaction with the musician's social media page may trigger an event and generate the interaction meta-data entry. The interaction meta-data entry may be transmitted to a local or remote database for further analysis and categorization. In this example, the interaction may be categorized as a music entry.

Additionally, the interests of other users with similar interactions with the musician may be analyzed. For example, the other users with similar interactions may prefer other content, such as other musician, movies, and/or merchandise. The user's profile may be updated to include the preference for the musician as well as the content preferred by other users with similar interactions.

The updated user profile may be distributed to APIs of multiple applications associated with the platform. The APIs may query for content associated with the updated user profile. As discussed, the API for a video streaming application may query for the preferred content. As another example, an API for an online shopping application may query for products associated with the preferred content.

In one configuration, the user's interactions with content improve a content search. For example, a user may interact with content, such as an email, text message, social media post, etc. The platform generates interaction meta-data that is analyzed and categorized. The categorized interaction is stored to the user's profile.

The user may search for previously interacted content via the platform's search function. The user may search for a text string, such as a name of a friend, message or post content, date, etc. The platform would return suggestions that match, or are related to, the query. The suggestions are provided regardless of a source of the content. Accordingly, the interaction meta-data provides an ability to search for previously interacted content across multiple data sources (e.g., applications and websites). Therefore, aspects of the present disclosure improve a user's ability to search for specific content.

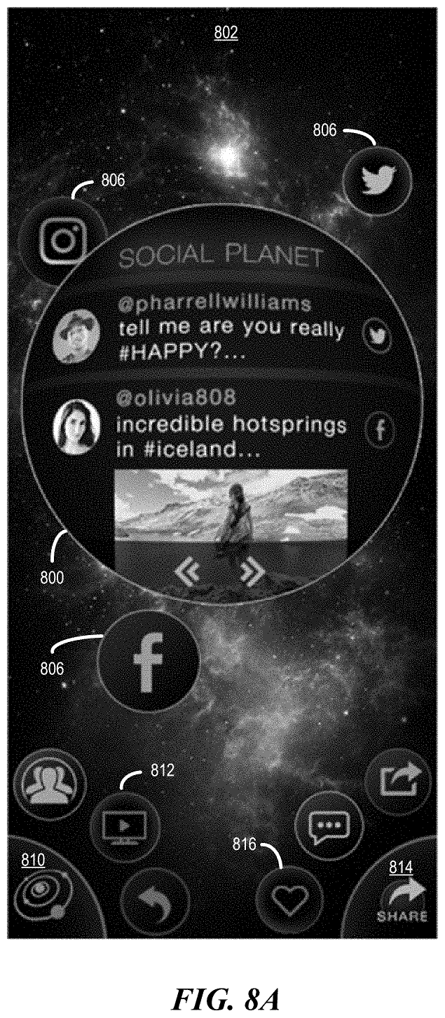

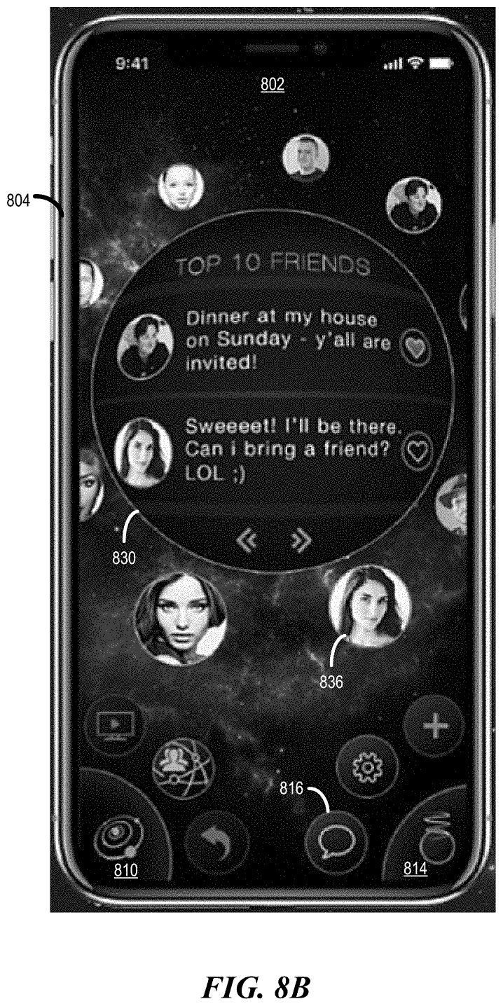

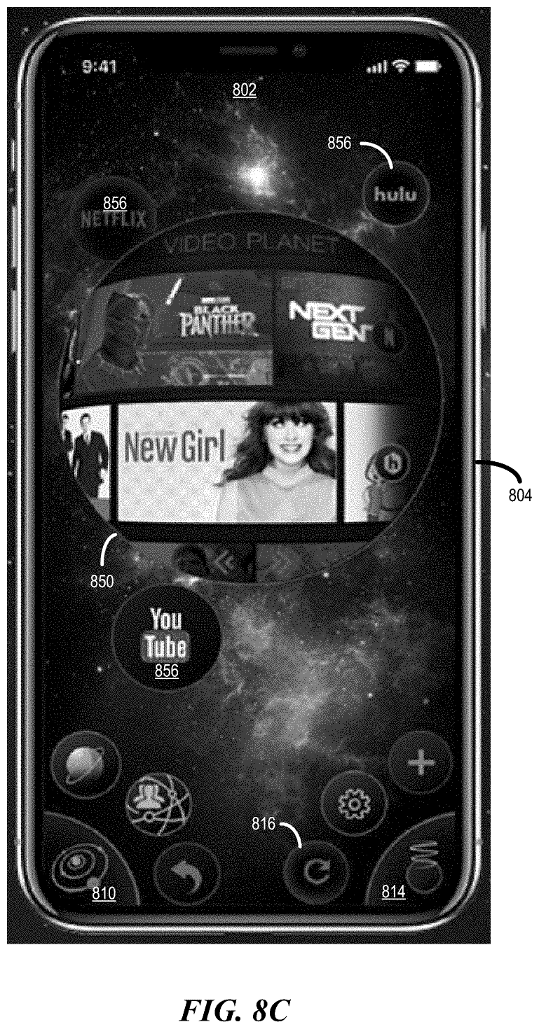

FIG. 8A illustrates an example of a first aggregator planet 800 of a 3D, rotational, GUI according to aspects of the present disclosure. As shown in FIG. 8A, the first aggregator planet 800 is displayed on a display 802 of a device. In this example, the first aggregator planet 800 is a social media planet.

That is, the first aggregator planet 800 combines data (e.g., a user's posts) from multiple social media applications associated with the platform. The combined data may be displayed in a scrollable feed. The data may be displayed in chronological order or prioritized based on the user profile. A user may select one of the posts to engage the creator of the post.

The feed may be vertically scrolled to reveal additional combined data. Additionally, the feed may be horizontally scrolled to display different columns of data. Each column may correspond to a data feed from one source, rather than data combined from multiple sources.

Additionally, as shown in FIG. 8A, content moons 806 orbit the aggregator planet 800. In this example, each content moon 806 corresponds to a different social media application. The feed of the aggregator planet 800 may be sourced from the social media applications displayed on the face of the content moons 806. A user may select one of the content moons 806 to execute the corresponding social media application. The content moons 806 may be animated to orbit around the aggregator planet 800.

The icons used for each content moon 806 may be obtained from the corresponding application, an API, or an external source (e.g., the Internet). If an application icon is not available, the icon may be obtained from an asset library. Icons are not limited to content moons 806. Icons may be displayed on aggregator planets in a home planet view.

The 3D, rotational, GUI also includes HUD controls 808. The HUD controls include a navigation control 810, navigation sub-controls 812, an action control 814, and action sub-controls 816. The navigation control 810 may be a shortcut to a home planet view. The navigation sub-controls 812 provide shortcuts to specific locations, such as a video planet or friends planet. The navigation sub-controls 812 may rotate around the navigation control 810.

The action control 814 may perform a specific action. The action sub-controls 816 may perform specific actions related to the type of aggregator planet 800 or type of content currently displayed at the 3D, rotational, GUI. In this example, the action sub-control 816 may provide functions corresponding to a social media planet, such as like a post, message a friend, share, etc. A set of action sub-controls 816 may be set for a default view. The set of action sub-controls 816 may be selected by a user, set by a developer, or set based on the user-profile.

FIG. 8B illustrates an example of a second aggregator planet 830 of a 3D, rotational, GUI according to aspects of the present disclosure. As shown in FIG. 8B, the second aggregator planet 830 is displayed on the display 802 of the device 804. In this example, the second aggregator planet 830 is a friends planet.

That is, the second aggregator planet 830 combines data, such as messages, from different friends. The friends may be in a user's contact list and/or social media connections. The messages may be text messages, social media messages, or messages received via another type of messaging platform. The combined data may be displayed in a scrollable feed. The data may be displayed in chronological order or prioritized based on the user profile. A user may select a displayed message to engage the message writer.

Additionally, as shown in FIG. 8B, content moons 836 orbit the second aggregator planet 830. In this example, each content moon 836 corresponds to a different friend. The content moons 836 may be limited to a subset of the user's friends. For example, the content moons 836 may be the top ten friends based on interaction. The user may also select the friends for the content moons 836. The user may select one of the content moons 836 to message the selected friend and/or visit the selected friend's planet.

As discussed, action sub-controls 816 may perform specific actions related to the type of aggregator planet 830 or type of content currently displayed at the 3D, rotational, GUI. In this example, the action sub-control 816 may provide functions corresponding to friends planet, such as message a friend, settings, add a friend, etc. The action sub-controls 816 of the second aggregator planet 830 are different from the action sub-control 816 of the first aggregator planet 800.

FIG. 8C illustrates an example of a third aggregator planet 850 of a 3D, rotational, GUI according to aspects of the present disclosure. As shown in FIG. 8C, the third aggregator planet 850 is displayed on the display 802 of the device 804. In this example, the third aggregator planet 850 is a video planet.

That is, the third aggregator planet 850 combines data, such as streaming video content, from different content providers. The content providers may be applications installed on the device or a content website. The combined video data may be displayed in a scrollable feed. The video data may be displayed in chronological order or prioritized based on the user profile. The video data may be displayed as a list of content, as tiles, or in another format.

Additionally, as shown in FIG. 8C, content moons 856 orbit the third aggregator planet 850. In this example, each content moon 856 corresponds to a different content provider (e.g., video content provider). The user may select one of the content moons 856 to access content from the specific content provider.

As discussed, action sub-controls 816 may perform specific actions related to the type of aggregator planet 850 or type of content currently displayed at the 3D, rotational, GUI. In this example, the action sub-control 816 may provide functions corresponding to video planet, such as play, settings, etc. The action sub-controls 816 of the third aggregator planet 850 are different from the action sub-control 816 of the first and second aggregator planets 800, 850.

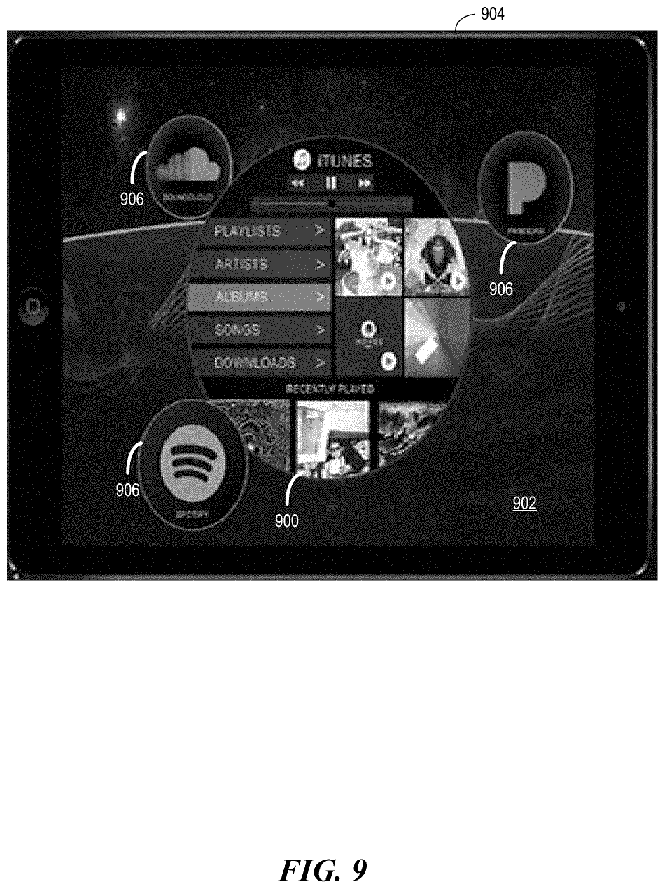

FIG. 9 illustrates an example of an aggregator planet 900 of a 3D, rotational, GUI according to aspects of the present disclosure. As shown in FIG. 9, the aggregator planet 900 is displayed on a display 902 of a device 904. In this example, the aggregator planet 900 is a music planet.

That is, the aggregator planet 900 combines data, such as streaming music content, from different content providers. The content providers may be applications installed on the device or a content website. The combined music data may be displayed in a scrollable feed. The music data may be displayed in chronological order or prioritized based on the user profile. The music data may be displayed as a list of content, as tiles, or in another format.

Additionally, as shown in FIG. 9, content moons 906 orbit the aggregator planet 900. In this example, each content moon 906 corresponds to a different content provider (e.g., music content provider). The user may select one of the content moons 906 to access content from the specific content provider. In FIG. 9, the HUD controls are not displayed. In one configuration, the HUD controls are hidden until activated by a user via an input or event.

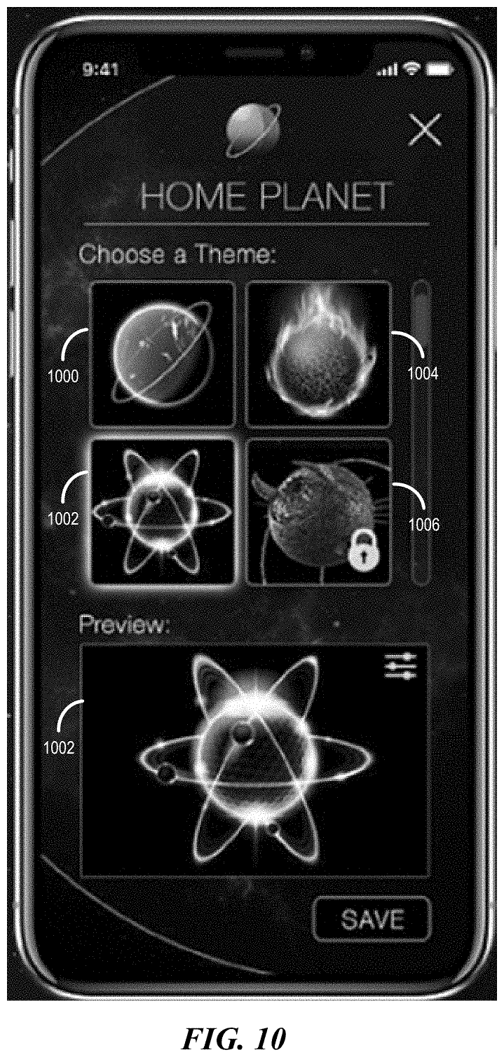

FIG. 10 illustrates examples of different skins 1000, 1002, 1004, 1006 for a home planet. Each skin 1000, 1002, 1004, 1006 may be associated with a different theme, such that the aggregator planets and content moons match the skin of the home planet. The skins 1000, 1002, 1004, 1006 are not limited to a planetary theme and may be any type of theme.

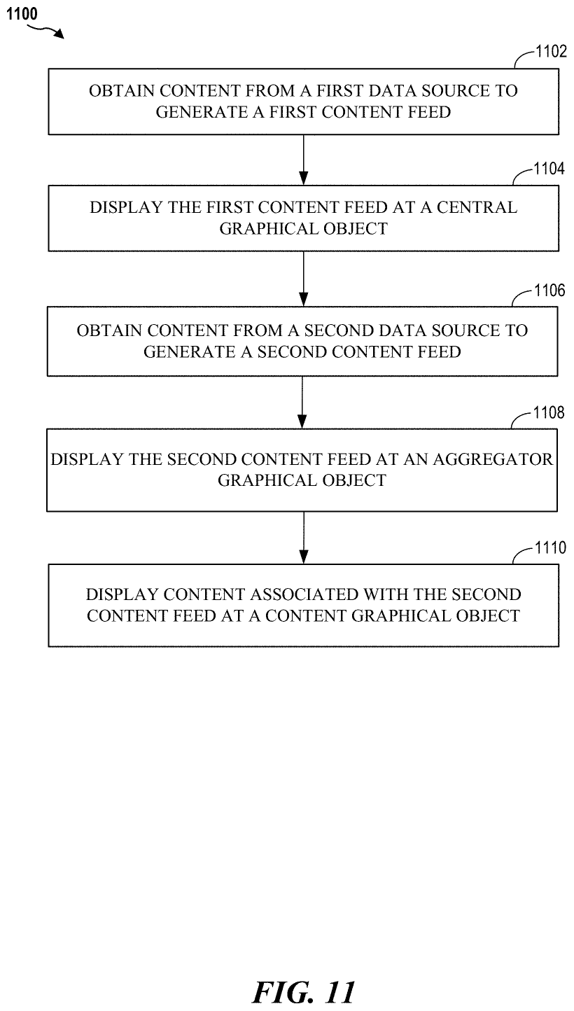

FIG. 11 illustrates a flow diagram 1100 for presenting content in a three-dimensional (3D) graphical user interface (GUI) according to aspects of the present disclosure. As shown in FIG. 11, at block 1102, a 3D GUI system obtains content from a first data source to generate a first content feed. The first data source may include a first application installed on a user device or an external data source (e.g., a website or a web application). The first content feed may also obtain data from other sources, such that the first content feed is aggregated from multiple data sources. At block 1104, the 3D GUI system displays the first content feed at a central graphical object. The central graphical object may be displayed as a central planet (e.g., home planet) in a solar system.

At block 1106, the 3D GUI system obtains content from a second data source to generate a second content feed. The second data source may include a second application installed on the user device or a second external data source (e.g., a website or a web application). The second application may be different from the first application. Additionally, the second external data source may be different from the first external data source. In one configuration, the first content feed also obtains data from the second application or the second external data source.

At block 1108, the 3D GUI system displays the second content feed at an aggregator graphical object. The aggregator graphical object may be displayed as a planet that orbits around the central graphical object. The orbit may be animated.

Additionally, at block 1110, the 3D GUI system displays content associated with the second content feed at a content graphical object. The content associated with the second content feed may include a short cut to third-party applications, a friends list, a web link, website content, website features, or other data. The content graphical object may be displayed as a moon orbiting the aggregator graphical object. The content graphical object may be displayed in a view that includes central graphical object and/or a zoomed view of the aggregator graphical object.

The graphics of the central graphical object, aggregator graphical object, and/or the content graphical object may be adjusted by the user. Additionally, aspects of the present disclosure are not limited to representing the central graphical object, aggregator graphical object, and the content graphical object as objects in a solar system. Other types of objects and systems are contemplated.

In an optional configuration, the 3D GUI system obtains content from a third data source. The third data source may be a third application installed on the user device or a third external data source (e.g., a website or a web application). The third application may be different from the first application and the second application. Additionally, the second external data source may be different from the first external data source. In one configuration, the first content feed also obtains data from the third application or the third external data source.

In one configuration, the third data source and the second data source are related in application type or content type. For example, the third data source and the second data source may both be video content applications/websites or social media applications/websites. The second content feed may aggregate content from the second data source with content from the third data source. That is, both the content from the second data source and the third data source may be displayed in the second content feed.

According to aspects of the present disclosure, the content displayed in the second content feed is prioritized based on a user's previous interactions with applications and other content on the user device. The interactions may be saved as interaction meta-data. The interaction meta-data may be used to build a user-profile. The user-profile may be shared across applications and/or websites across the 3D GUI system.

In one configuration, the 3D GUI system displays a heads-up display interface that includes navigation controls and action controls. The navigation controls include shortcuts to navigate to other areas of the 3D GUI system. For example, the shortcuts may navigate to one or more aggregator graphical objects or content graphical objects. The action controls include functionality controls that correspond to a type of content currently displayed. For example, if video content is currently displayed, the action controls may include video controls (e.g., play, pause, fast forward, rewind, etc.).

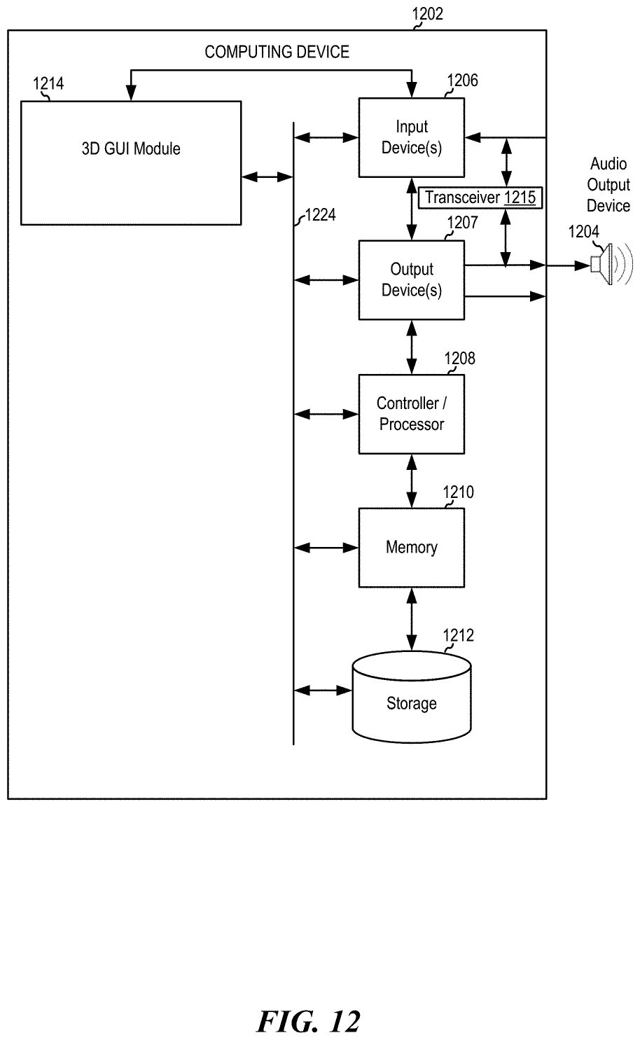

FIG. 12 is a block diagram conceptually illustrating a computing device 1202, according to one aspect of the present disclosure. Aspects of the present disclosure include computer-readable and computer-executable instructions that may reside on the computing device 1202. FIG. 12 illustrates a number of components that may be included in the computing device 1202, however, other non-illustrated components may also be included. Additionally, some of the illustrated components may not be present in every device capable of employing aspects of the present disclosure. Further, some components that are illustrated in the computing device 1202 as a single component may also appear multiple times in a single device.

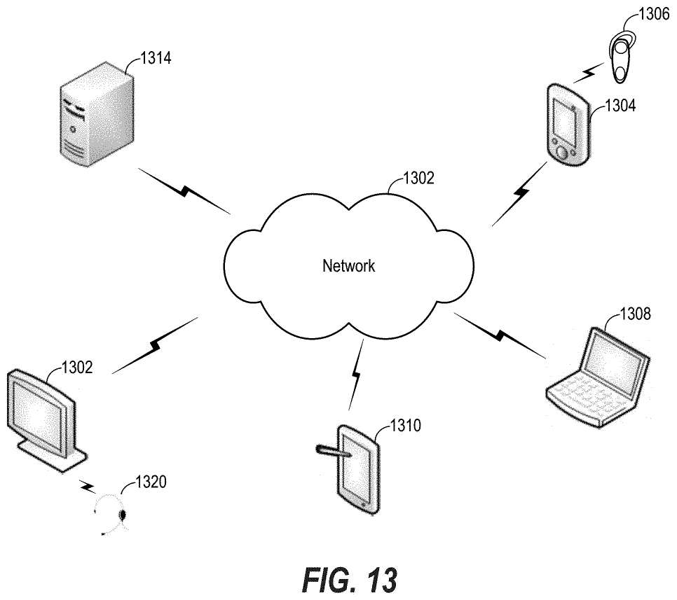

For example, the computing device 1202 may include one or more input devices 1206, one or more output devices 1207, and/or one or more controllers/processors 1208. The computing device 1202 may include a 3D, rotational, GUI (3D GUI). The 3D GUI may be a component of the native operating system. Alternatively, the 3D GUI may be installed as a component of the native operating system, such that the 3D GUI is a layer above the UI of the native operating system. The computing device 1202 may include a 3D GUI module 1214 to facilitate operation of the 3D GUI. The computing device 1202 also includes a transceiver 1215. The transceiver 1215 is coupled to one or more antennas (not shown). The transceiver 1215 enables the computing device 1202 to communicate with other apparatus over a transmission medium (e.g., network 1302 discussed below with reference to FIG. 13).

Aspects of the present disclosure may be applied within a number of different devices and computer systems, including, for example, server-client computing systems, mainframe computing systems, telephone computing systems, laptop computers, cellular phones, personal digital assistants (PDAs), tablet computers, other mobile devices, etc. Aspects of the present disclosure may also be applied to home appliances (such as refrigerators, ovens, etc.), vehicles (such as cars, buses, motorcycles, etc.), and/or ebook readers, for example.

As illustrated in FIG. 12, the computing device 1202 may include an audio output device 1204 for outputting audio to a user. The audio output device 1204 may include a speaker, headphone, or another suitable component for emitting sound. The audio output device 1204 may be integrated into the computing device 1202 or may be separate from the computing device 1202. The computing device 1202 may also include an address/data bus 1224 for conveying data among components of the computing device 1202. Each component within the computing device 1202 may also be directly connected to other components in addition to (or instead of) being connected to other components across the bus 1224. Although certain components are illustrated in FIG. 12 as directly connected, these connections are illustrative only and other components may be directly connected to each other (such as the 3D GUI module 1214 to the controller/processor 1208).

The computing device 1202 may include a controller/processor 1208 that may be a central processing unit (CPU) for processing data and computer-readable instructions and the memory 1210 for storing data and instructions. The memory 1210 may include volatile random access memory (RAM), non-volatile read-only memory (ROM), and/or other types of memory. The computing device 1202 may also include the data storage component 1212 for storing data and instructions. The data storage component 1212 may include one or more storage types such as magnetic storage, optical storage, solid-state storage, etc.

The computing device 1202 may also be connected to removable or external memory and/or storage (such as a removable memory card, memory key drive, networked storage, etc.) through the input device 1206 or the output device 1207. Computer instructions for processing by the controller/processor 1208 for operating the computing device 1202 and its various components may be executed by the controller/processor 1208 and stored in the memory 1210, storage 1212, or external device. Alternatively, some or all of the executable instructions may be embedded in hardware or firmware in addition to or instead of software. The aspects of this disclosure may be implemented in various combinations of software, firmware, and/or hardware, for example.

The computing device 1202 includes the input device(s) 1206 and the output device(s) 1207. A variety of input/output device(s) may be included in the device. Example input devices 1206 include an audio input device (e.g., microphone), a touch input device, a keyboard, a mouse, a stylus or other input devices. Example output devices 1207 include a visual display, a tactile display, audio speakers, headphones, or another output device. The 3D GUI module 1214 may output the 3D GUI via the output device 1207. The input device(s) 1206 and/or output device(s) 1207 may also include an interface for an external peripheral device connection such as universal serial bus (USB), FireWire, Thunderbolt or other connection protocol. The input device(s) 1206 and/or output device(s) 1207 may also include a network connection such as an Ethernet port, modem, etc.

The input device(s) 1206 and/or output device(s) 1207 may also include a wireless communication device, such as radio frequency (RF), infrared, Bluetooth, wireless local area network (WLAN) (such as WiFi), or wireless network radio, such as a radio capable of communication with a wireless communication network such as a long term evolution (LTE) network, WiMAX network, 3G network, 4G network, 5G network, etc. Through the transceiver 1215, the input device(s) 1206, the output device(s) 1207, and/or the computing device 1202 may connect to a network, such as the Internet or private network, which may include a distributed computing environment.

The 3D GUI module 1214 may be a software module or a hardware module. The 3D GUI module 1214 may store user information, such as meta-data entries, in the memory 1210 and/or storage 1212. The 3D GUI module 1214 may also communicate with an external server via the transceiver 1215. For example, the 3D GUI module 1214 may transmit meta-data to an external server and receive update user profile data from the server.

FIG. 13 illustrates a computer network 1302 with various devices that may use a 3D, rotational GUI according to aspects of the present disclosure. As shown in FIG. 13, multiple devices may be connected over the network 1302. The network 1302 may include a local or private network or may include a wide network such as the Internet. Devices may be connected to the network 1302 through either wired or wireless connections. For example, a wireless device 1304 may be connected to the network 1302 through a wireless service provider. Other devices, such as computer 1314, may connect to the network 1302 through a wired connection. Other devices, such as a laptop 1308 or tablet computer 1310 may be capable of connecting to the network 1302 using various connection methods including through a wireless service provider, over a WiFi connection, or the like. Networked devices may output synthesized speech through a number of audio output devices including headsets 1306 or 1320. Audio output devices may be connected to networked devices either through a wired or wireless connection. Networked devices may also include embedded audio output devices, such as an internal speaker in the laptop 1308, wireless device 1304, or tablet computer 1310.

Based on the teachings, one skilled in the art should appreciate that the scope of the present disclosure is intended to cover any aspect of the present disclosure, whether implemented independently of or combined with any other aspect of the present disclosure. For example, an apparatus may be implemented or a method may be practiced using any number of the aspects set forth. In addition, the scope of the present disclosure is intended to cover such an apparatus or method practiced using other structure, functionality, or structure and functionality in addition to, or other than the various aspects of the present disclosure set forth. It should be understood that any aspect of the present disclosure may be embodied by one or more elements of a claim.

The word “exemplary” is used herein to mean “serving as an example, instance, or illustration.” Any aspect described herein as “exemplary” is not necessarily to be construed as preferred or advantageous over other aspects.

Although particular aspects are described herein, many variations and permutations of these aspects fall within the scope of the present disclosure. Although some benefits and advantages of the preferred aspects are mentioned, the scope of the present disclosure is not intended to be limited to particular benefits, uses or objectives. Rather, aspects of the present disclosure are intended to be broadly applicable to different technologies, system configurations, networks and protocols, some of which are illustrated by way of example in the figures and in the following description of the preferred aspects. The detailed description and drawings are merely illustrative of the present disclosure rather than limiting, the scope of the present disclosure being defined by the appended claims and equivalents thereof.

As used herein, the term “determining” encompasses a wide variety of actions. For example, “determining” may include calculating, computing, processing, deriving, investigating, looking up (e.g., looking up in a table, a database or another data structure), ascertaining and the like. Additionally, “determining” may include receiving (e.g., receiving information), accessing (e.g., accessing data in a memory) and the like. Furthermore, “determining” may include resolving, selecting, choosing, establishing, and the like.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules and circuits described in connection with the present disclosure may be implemented or performed with a processor specially configured to perform the functions discussed in the present disclosure. The processor may be a neural network processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. Alternatively, the processing system may comprise one or more neuromorphic processors for implementing the neuron models and models of neural systems described herein. The processor may be a microprocessor, controller, microcontroller, or state machine specially configured as described herein. A processor may also be implemented as a combination of computing devices, e.g., a combination of a DSP and a microprocessor, a plurality of microprocessors, one or more microprocessors in conjunction with a DSP core, or such other special configuration, as described herein.

The steps of a method or algorithm described in connection with the present disclosure may be embodied directly in hardware, in a software module executed by a processor, or in a combination of the two. A software module may reside in storage or machine readable medium, including random access memory (RAM), read-only memory (ROM), flash memory, erasable programmable read-only memory (EPROM), electrically erasable programmable read-only memory (EEPROM), registers, a hard disk, a removable disk, a CD-ROM or other optical disk storage, magnetic disk storage or other magnetic storage devices, or any other medium that can be used to carry or store desired program code in the form of instructions or data structures and that can be accessed by a computer. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware, or any combination thereof. If implemented in hardware, an example hardware configuration may comprise a processing system in a device. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement signal processing functions. For certain aspects, a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further.

The processor may be responsible for managing the bus and processing, including the execution of software stored on the machine-readable media. Software shall be construed to mean instructions, data, or any combination thereof, whether referred to as software, firmware, middleware, microcode, hardware description language, or otherwise.

In a hardware implementation, the machine-readable media may be part of the processing system separate from the processor. However, as those skilled in the art will readily appreciate, the machine-readable media, or any portion thereof, may be external to the processing system. By way of example, the machine-readable media may include a transmission line, a carrier wave modulated by data, and/or a computer product separate from the device, all which may be accessed by the processor through the bus interface. Alternatively, or in addition, the machine-readable media, or any portion thereof, may be integrated into the processor, such as the case may be with cache and/or specialized register files. Although the various components discussed may be described as having a specific location, such as a local component, they may also be configured in various ways, such as certain components being configured as part of a distributed computing system.

The machine-readable media may comprise a number of software modules. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a special purpose register file for execution by the processor. When referring to the functionality of a software module below, it will be understood that such functionality is implemented by the processor when executing instructions from that software module. Furthermore, it should be appreciated that aspects of the present disclosure result in improvements to the functioning of the processor, computer, machine, or other system implementing such aspects.

If implemented in software, the functions may be stored or transmitted over as one or more instructions or code on a computer-readable medium. Computer-readable media include both computer storage media and communication media including any storage medium that facilitates a transfer of a computer program from one place to another.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means, such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

What is claimed is:

1. A method for presenting content in a three-dimensional graphical user interface (GUI), comprising:
obtaining content from at least a first data source to generate a first content feed;
displaying the first content feed at a central graphical object;
obtaining content from at least a second data source to generate a second content feed;
displaying the second content feed at an aggregator graphical object; and
displaying content associated with the second content feed at a content graphical object.

2. The method of claim 1, in which:
the aggregator graphical object is animated to rotate around the central graphical object; and
the content graphical object is animated to rotate around the aggregator graphical object.

3. The method of claim 1, in which:
the first data source comprises a first application installed on a user device or a first external data source; and
the second data sources comprises a second application installed on the user device or a second external data source.

4. The method of claim 3, in which:
the second external data source comprises a website or a web application; and
the content associated with the second content feed comprises content associated with the website or the web application.

5. The method of claim 1, further comprising:
obtaining content from a third data source, the third data source and the second data source related in at least one of application type or content type; and
aggregating the content from the second data source with the content from the third data source to generate the second content feed.

6. The method of claim 5, further comprising:
prioritizing content displayed in the second content feed based on a user's previous interactions with applications and other content on the user device.

7. The method of claim 1, further comprising displaying a heads-up display interface comprising navigation controls and action controls.

8. The method of claim 7, in which:
the navigation controls comprise shortcuts to navigate to at least one of the aggregator graphical object or the content graphical object; and
the action controls comprise functionality controls corresponding to a type of content currently displayed.

9. An apparatus for presenting content in a three-dimensional graphical user interface (GUI), the apparatus comprising:
a memory; and
at least one processor coupled to the memory, the at least one processor configured:
to obtain content from at least a first data source to generate a first content feed;
to display the first content feed at a central graphical object;
to obtain content from at least a second data source to generate a second content feed;
to display the second content feed at an aggregator graphical object; and
to display content associated with the second content feed at a content graphical object.

10. The apparatus of claim 9, in which:
the aggregator graphical object is animated to rotate around the central graphical object; and
the content graphical object is animated to rotate around the aggregator graphical object.

11. The apparatus of claim 9, in which:
the first data source comprises a first application installed on a user device or a first external data source; and
the second data sources comprises a second application installed on the user device or a second external data source.

12. The apparatus of claim 11, in which:
the second external data source comprises a website or a web application; and
the content associated with the second content feed comprises content associated with the website or the web application.

13. The apparatus of claim 9, in which the at least one processor is further configured:
to obtain content from a third data source, the third data source and the second data source related in at least one of application type or content type; and
to aggregate the content from the second data source with the content from the third data source to generate the second content feed.

14. The apparatus of claim 13, in which the at least one processor is further configured to prioritize content displayed in the second content feed based on a user's previous interactions with applications and other content on the user device.

15. The apparatus of claim 9, in which the at least one processor is further configured to display a heads-up display interface comprising navigation controls and action controls.

16. The apparatus of claim 15, in which:
the navigation controls comprise shortcuts to navigate to at least one of the aggregator graphical object or the content graphical object; and
the action controls comprise functionality controls corresponding to a type of content currently displayed.

17. A non-transitory computer-readable medium having program code recorded thereon for presenting content in a three-dimensional graphical user interface (GUI), the program code executed by a processor and comprising:
program code to obtain content from at least a first data source to generate a first content feed;
program code to display the first content feed at a central graphical object;
program code to obtain content from at least a second data source to generate a second content feed;
program code to display the second content feed at an aggregator graphical object; and
program code to display content associated with the second content feed at a content graphical object.

18. The non-transitory computer-readable medium of claim 17, in which:
the aggregator graphical object is animated to rotate around the central graphical object; and
the content graphical object is animated to rotate around the aggregator graphical object.

19. The non-transitory computer-readable medium of claim 17, in which:
the first data source comprises a first application installed on a user device or a first external data source; and
the second data sources comprises a second application installed on the user device or a second external data source.

20. The non-transitory computer-readable medium of claim 19, in which:
the second external data source comprises a website or a web application; and
the content associated with the second content feed comprises content associated with the website or the web application.
